(19) United States
(12) Patent Application Publication
(10) Pub. No.: US 2006/0291254 A1
(43) Pub. Date: Dec. 28, 2006

(54) Flat panel display device and backlight assembly therefor

(75) Inventors: Soo-Im Jeong, Suwon-si (KR); Yong-Taek Hwang, Cheonan-si (KR); An-Na Park, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/478,002

(22) Filed: Jun. 28, 2006

(30) Foreign Application Priority Data
Jun. 28, 2005 (KR) 10-2005-0056146

(51) Int. Cl. F21V 7/04

(52) U.S. Cl. 362/632

(57) ABSTRACT

A backlight assembly and a flat panel display including the same are provided, the backlight assembly comprising a light source for emitting light to a panel unit and a plurality of peripheral components disposed at a bottom side and a lateral side of the light source and supporting the light source. At least some of the plurality of peripheral components are composed of a material comprising a polymer resin of which the molecular weight is about 40,000 to about 60,000.

### CROSS-REFERENCE TO RELATED APPLICATION

This application claims priority to and the benefit of Korean Patent Application No. 10-2005-0056146 filed in the Korean Intellectual Property Office on Jun. 28, 2005, the entire contents of which are incorporated herein by reference.

### BACKGROUND OF THE INVENTION

(a) Field of the Invention

The present invention relates to a flat panel display and a backlight assembly therefor.

(b) Description of the Related Art

Recently, based on semiconductor technology that has been rapidly developed, the demand for liquid crystal display (LCD) having improved performance together with a reduced size and a light weight has explosively increased.

An LCD device has been attractive as a replacement of other information display devices, since it is thinner and lighter, and it consumes less power than others.

The LCD device is a non-emissive display device that displays information using modulation of the light that passes through the liquid crystal cell. A general LCD applies a voltage to liquid crystal molecules with a predetermined alignment to convert them to another alignment, and converts a change of optical properties such as birefringence, optical rotation, dichroism, and optical scattering of a liquid crystal cell into a visual change.

In the case of a large LCD being used in a television, a plurality of lamps are used in realizing a high definition image. The plurality of lamps are supported with a bottom chassis, a lamp holder, a lamp supporter, and a frame mold side at a bottom side and a lateral side thereof, which protect the lamps from external impacts.

The bottom chassis, the lamp holder, the lamp supporter, and the frame mold side are exposed directly to light and heat emitted from the lamp, which gives rise to a so called “yellowing” effect after long-time use. The yellowing effect is one of the major causes that shorten the lifetime of large liquid crystal devices and deteriorate characteristics thereof. Therefore, an apparatus with a reduced yellowing effect and having an improved lifetime is highly desirable.

The above information disclosed in this Background section is only for enhancement of understanding of the background of the invention and therefore it may contain information that does not form the prior art that is known to a person of ordinary skill in the art.

### SUMMARY

A backlight assembly according to an embodiment of the present invention includes a light source and a peripheral component supporting the light source. The peripheral component may include a polymer resin having an average molecular weight equal to or greater than about 40,000.

A flat panel display device according to another embodiment of the present invention includes a panel assembly for displaying an image, and a backlight assembly, comprising a light source for emitting light to the panel assembly and a plurality of peripheral components supporting the light source. At least one of the peripheral components may include polycarbonate having an average molecular weight from about 40,000 to about 60,000.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The present invention will become more apparent by describing embodiments thereof in detail with reference to the accompanying drawings, in which:

FIG. 1 is an exploded perspective view of the backlight assembly according to an embodiment of the present invention;

FIG. 2 is a cross-sectional view of the backlight assembly of FIG. 1;

FIG. 3 is an exploded perspective view of the flat panel display provided with a backlight assembly according to an embodiment of the present invention; and

FIG. 4 is a graph showing a change in average molecular weight of polycarbonates by UV irradiation.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

Embodiments of the present invention will be described more fully hereinafter with reference to the accompanying drawings, in which embodiments of the invention are shown. The present invention may, however, be embodied in different forms and should not be construed as being limited to the embodiments set forth herein. Rather, these embodiments are provided so that this disclosure will be thorough, and will more fully convey the scope of the invention to those skilled in the art.

To clearly show multiple layers and regions, the thicknesses of the layers may be enlarged in the drawings. Furthermore, like reference numerals designate like elements throughout the specification.

It will be understood that when an element such as a layer, film, region, or substrate is referred to as being “on” another element, it can be directly on the other element or intervening elements may also be present. On the other hand, if any part is said to be positioned directly on another part it means that there is no intermediate part between the two parts.

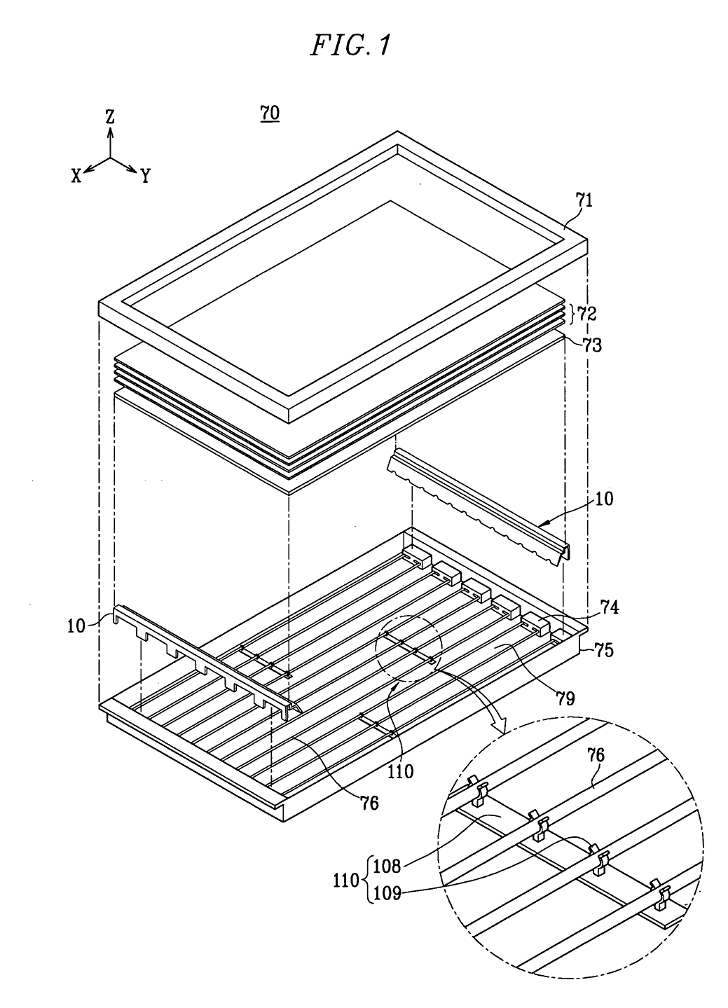

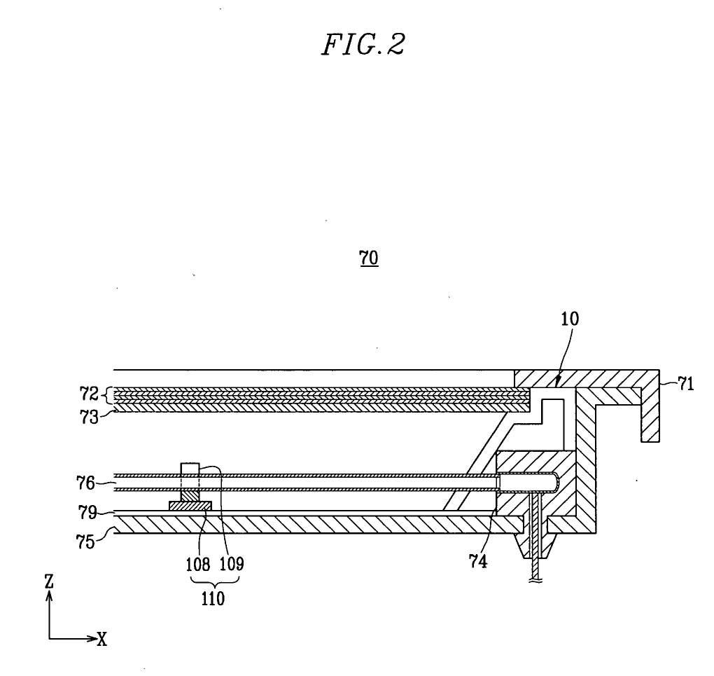

Now, a backlight assembly according to an embodiment of the present invention will be described in detail with reference to FIGS. 1 and 2.

FIG. 1 is an exploded perspective view of the backlight assembly according to an embodiment of the present invention, and FIG. 2 is a cross-sectional view of the backlight assembly shown in FIG. 1.

FIG. 1 and FIG. 2 show a direct-lighting type backlight assembly 70 that may be used in a large television and various other displays.

A structure of the backlight assembly 70 shown in FIG. 1 and FIG. 2 is intended only to show an embodiment of the present invention, and thus the present invention is not limited thereto. Therefore, the present invention may be applied to backlight assemblies having other structures.

The backlight assembly 70 includes a mold frame 71, a plurality of optical sheets 72, a diffusing plate 73, lamps 76, lamp holders 74, frame mold sides 10, lamp supporters 110, a bottom chassis 75, and a reflecting sheet 79. The backlight assembly 70 diffuses light emitted from the lamps 76 to make the light uniform, and then directs the uniform light upwardly (in the Z axis direction).

The bottom chassis 75 receives internal components including the lamps 76, the lamp holders 74, the lamp supporters 110, the frame mold sides 10, and the reflecting sheet 79. The mold frame 71 is disposed on and combined with the bottom chassis 75.

The lamps 76 are disposed on the bottom chassis 75 in parallel at predetermined intervals in one embodiment. Cold cathode fluorescent lamps (CCFLs) may be used for the lamps 76 in one example.

The lamp holders 74 are provided near the ends of the lamps 76, thereby fixing and supporting the lamps 76. The lamp holders 74 are fixed to openings (not shown) formed in the bottom chassis 75, thereby firmly supporting the lamps 76 while moving or transferring the backlight assembly 70.

Each of the lamp supporters 110 is disposed under the lamps 76 and includes a transversal member 108 and fixing members 109 disposed thereon. The transversal member 108 crosses some of the lamps 76 in one example, and the fixing members 109 are coupled to the upper side of the transversal member 108 and fix the lamps 76. The lamp supporters 110 support the lamps 76 and prevent them from sagging along their lengths.

The frame mold sides 10 cover and fix the lamp holders 74.

The reflecting sheet 79 is disposed under the lamps 76 and covers an entire inner surface of the bottom chassis 75 in one example, thereby reflecting the light emitted from the lamps 76.

The peripheral components for fixing the lamps 76 such as the bottom chassis 75, the lamp holders 74, the lamp supporters 110, and the frame mold sides 10 primarily include a polymer resin such as polycarbonate. The polymer resin has an average molecular weight equal to or greater than about 40,000 in one example, and the average molecular weight may be equal to or smaller than about 60,000 in a second example. Advantageously, the above-described polymer resin is resistant to the yellowing effect and has a good molding property.

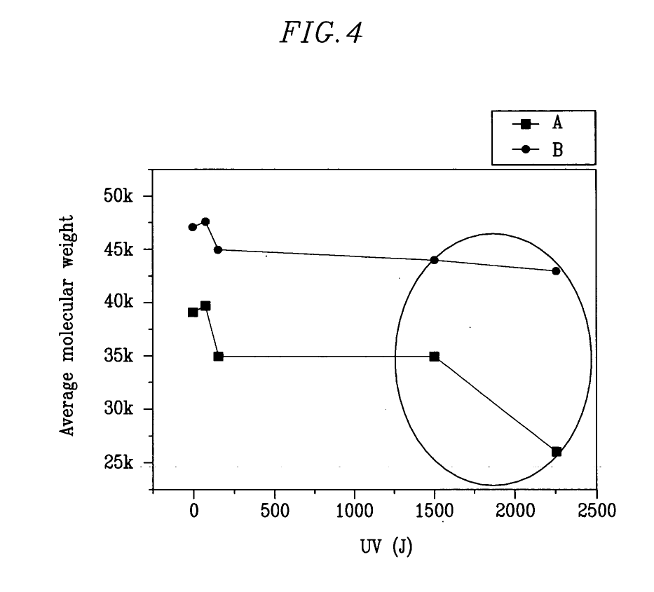

FIG. 4 is a graph showing the change in average molecular weight of polycarbonates when exposed to UV irradiation. As shown in FIG. 4, when the molecular weight of polycarbonate is larger than about 40,000 (data B), the change in molecular weight when increasing UV irradiation is negligible, but when the molecular weight of polycarbonate is equal to about 35,000 (data A), the molecular weight dramatically changes by the time UV irradiation reaches 1500 J. The drastic change of the molecular weight may be caused by the rapid increase of the decomposition rate.

Accordingly, the peripheral components, such as the bottom chassis 75, the lamp holders 74, the lamp supporters 110, and the frame mold sides 10, which are directly exposed to light and heat emitted from the lamps 76, may include polycarbonate of molecular weight greater than about 40,000 thereby making the yellowing rate appreciably slower since the yellowing may be caused by the decomposition of the polymer resin. However, it may be difficult to mold or otherwise process polycarbonate that has a molecular weight over about 60,000. Accordingly, it is preferable that the peripheral components such as the bottom chassis 75, the lamp holders 74, the lamp supporters 110, and the frame mold sides 10, include polycarbonate of molecular weight from about 40,000 to about 60,000.

The bottom chassis 75, the lamp holders 74, the lamp supporters 110, and the frame mold sides 10 may further include an antioxidant, a light stabilizer, a brightener, an impact stiffener, and phosphorus-containing additives in addition to the polymer resin.

The antioxidant includes a low-volatility phenol compound, for example at least one selected from 1,3,5-tris(3′,5′-di-t-butyl-4′-hydroxybenzyl)-s-trizine-2,4,6-(1H,3H,5H)-trione and 1,3,5-tris(4-t-butyl-3-hydroxy-2,6-diethylbenzyl)-s-trizine-2,4,6-(1H, 3H,5H)-trione. Since the phenol compound has low volatility and is strongly intermolecularly bonded, the decomposition rate caused by the light is low and thus the yellowing rate is also reduced. The antioxidant content is below about 0.5 wt % of the total weight of the polymer resin and the various additives in one example.

The light stabilizer includes at least one selected from benzotriazole or a derivative thereof, and an amine compound. An example of the amine compound is a hindered amine light stabilizer (HALS) such as a piperidine-hindered amine or 2-(2′-hydroxy phenyl)benzotriazole. The light stabilizer is bonded to radicals produced by UV light so as to suppress polycarbonate decomposition as a result of interaction with the UV light.

The brightener includes titanium oxide (TiO2) and an under-surface treatment using alumina or silica in one example. The titanium oxide is photo-reactive to induce oxidization of the polymer resin. Accordingly, the oxidation rate and suppress photo-reaction can be reduced by forming a surface treatment layer of a material such as alumina or silica between the titanium oxide and the polymer resin. The titanium oxide is classified into rutile titanium oxide and anatase titanium oxide with a crystalline shape in one example. Since light scattering efficiency of utile titanium oxide is greater than that of rutile titanium oxide by more than 30%, rutile titanium oxide suppresses yellowing more efficiently.

The light emitted from the lamps 76 is uniformly diffused while passing through the diffusing plate 73. The optical sheets 72 that are disposed above the diffusing plate 73 improve the brightness of the light. Therefore, uniform light with improved brightness is supplied to the upper side.

Advantageously, the backlight assembly 70 is firm enough to resist external impacts.

An inverter (not shown) which is formed as a printed circuit board (PCB) for supplying electrical power is provided at the rear surface of the bottom chassis 75. The inverter transforms an externally-supplied voltage into a predetermined voltage and applies the predetermined voltage to the lamps 76 to emit the light.

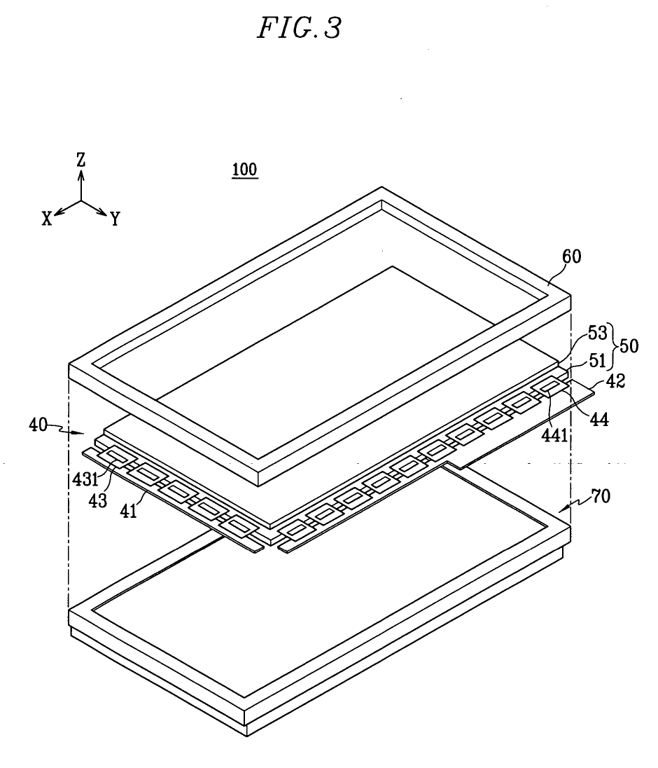

FIG. 3 is an exploded perspective view of a flat panel display including a backlight assembly according to an embodiment of the present invention. FIG. 3 shows a flat panel display 100 including a liquid crystal display (LCD) panel assembly 40 disposed between a backlight assembly 70 and a top chassis 60.

The LCD panel assembly 40 shown in FIG. 3 is an example of the flat panel display according to an embodiment of the present invention and the present invention is not limited thereto. Accordingly, a light-receiving panel unit having other structures may also be used.

The flat panel display 100 is manufactured by assembling the top chassis 60 with the backlight assembly 70 while interposing the LCD panel assembly 40 between the backlight assembly 70 and the top chassis 60.

The LCD panel assembly 40 includes LCD panels 50, chip-on-film (COF) 43 and 44, printed circuit boards (PCBs) 41 and 42, and so on. The COF 43 and 44 are coupled to the LCD panels 50 and supply driving signals therefor, and the PCBs 41 and 42 can be located at lateral sides of the top chassis-60.

The LCD panels 50 include a thin film transistor (TFT) array panel 51 including a plurality of thin film transistors (TFT) and a common electrode panel 53 positioned above the TFT array panel 51 with a liquid crystal layer (not shown) interposed between these panels 51 and 53.

Attached to the upper surface of common electrode panel 53 and the lower surface of the TFT array panel 51 are polarizers (not shown) that polarize the light passing through the LCD panels 50.

The TFT array panel 51 includes a plurality of TFTs (not shown) arranged in a matrix shape. Each of the TFTs has a gate terminal connected to a gate line (not shown), a source terminal connected to a data line (not shown), and a drain terminal coupled to a pixel electrode (not shown).

The pixel electrode includes transparent conductive material such as indium tin oxide (ITO).

Electrical signals are input to the gate lines and the data lines from the PCBs 41 and 42 and transmitted to the gate terminals and the source terminals of the TFTs, thereby turning on or turning off the TFTs to output electrical signals to the pixel electrodes through the drain terminals of the TFTs.

On the other hand, the common electrode panel 53 is positioned opposite to the TFT array panel 51.

The common electrode panel 53 includes red, green, and blue color filters (not shown) and a common electrode (not shown). The color filters are provided for color display and formed by thin film forming processes. The common electrode is made of transparent material, such as ITO, and covers the,entire surface of the common electrode panel 53. The common electrode is supplied with a common voltage.

An electric field is formed in the liquid crystal layer between the pixel electrode and the common electrode.

The electric field changes tilt angles of liquid crystal molecules, which in turn changes light transmittance to display an image.

The PCBs 41 and 42 receive image signals from outside of the flat panel display 100 and generates control signals for to the gate lines and the data lines. The PCBs 41 and 42 are respectively connected to the COFs 43 and 44 that are attached to the LCD panels 50.

In order to drive the flat panel display 100, the PCBs 41 and 42 includes a gate PCB 41 generating gate control signals and a data PCB 42 generating data control signals.

According to the image signals, the gate control signals, and the data control signals supplied from the PCBs 41 and 42, integrated chips 431 and 433 mounted on the COFs 43 and 44 generate electrical signals and apply the electrical signals to the gate lines and the data lines on the LCD panels 50.

A control board (not shown) may be mounted on the rear surface of the backlight assembly 70. The control board is connected to the data PCB 42, and converts analog image signals into digital image signals and then supplies the digital image signals to the LCD panel assembly.40.

The top chassis 60 bends the COF 43 and 44 to lateral sides of the backlight assembly 70 and fixes the LCD panel assembly 40 on the backlight assembly 70.

A front case and a side case (not shown in the FIG. 1) may be disposed on the top chassis 60 and under the bottom chassis 75, respectively, and then they may be assembled into the flat panel display 100.

The above-described flat panel display 100 has improved heat resistance to reduce the degradation of the liquid crystal layer in the LCD panel 50

As described above, the molecular weight and the chemical composition contained in the peripheral components of the lamp, which are directly exposed to the light emitted from the lamp, are modified to appreciably reduce the yellowing rate. Accordingly, the lifetime can be prolonged and the characteristics of a large flat panel display are improved.

While this invention has been described in connection with figures and embodiments as described above, it is to be understood that the invention is not limited to the disclosed embodiments, but, on the contrary, is intended to cover various modifications and equivalent arrangements included within the spirit and scope of the appended claims.

What is claimed is:

1. A backlight assembly, comprising:
a light source; and
a peripheral component supporting the light source,
wherein the peripheral component comprises a polymer resin having an average molecular weight equal to or greater than about 40,000.

2. The backlight assembly of claim 1, wherein the average molecular weight of the peripheral component is equal to or smaller than about 60,000.

3. The backlight assembly of claim 1, wherein the polymer resin comprises polycarbonate.

4. The backlight assembly of claim 1, wherein the peripheral component comprises:
a lamp holder provided on a lateral side of the light source and fixing and supporting the light source;
a frame mold side covering and supporting the lamp holder; and
a bottom chassis receiving the lamp holder and the frame mold side.

5. The backlight assembly of claim 1, wherein the light source comprises a cold cathode fluorescent lamp (CCFL).

6. The backlight assembly of claim 1, wherein the peripheral component further comprises at least one of an antioxidant, a brightener, and a light stabilizer.

7. The backlight assembly of claim 6, wherein the antioxidant comprises a phenol compound.

8. The backlight assembly of claim 7, wherein the antioxidant comprises at least one selected from 1,3,5-tris(3′,5′-di-t-butyl-4′-hydroxybenzyl)-s-trizine-2,4,6-(1H,3H,5H)-trione and 1,3,5-tris(4-t-butyl-3-hydroxy-2,6-diethylbenzyl)-s-trizine-2,4,6-(1H, 3H,5H)-trione.

9. The backlight assembly of claim 6, wherein the antioxidant content is below about 0.5 wt % of the total weight of the peripheral component.

10. The backlight assembly of claim 6, wherein the brightener comprises titanium oxide (TiO₂) and an under surface treatment using alumina or silica.

11. The backlight assembly of claim 10, wherein the titanium oxide comprises rutile titanium oxide.

12. The backlight assembly of claim 6, wherein the light stabilizer comprises at least one selected from benzotriazole or a derivative thereof and an amine compound.

13. The backlight assembly of claim 12, wherein the light stabilizer comprises at least one selected from a hindered amine light stabilizer (HALS) and 2-(2′-hydroxy phenyl)benzotriazole.

14. The backlight assembly of claim 1, further comprising a diffusing plate for diffusing the light emitted from the light source.

15. A flat panel display device, comprising:
a panel assembly for displaying an image; and
a backlight assembly, comprising a light source for emitting light to the panel unit and a plurality of peripheral components supporting the light source,
wherein at least one of the peripheral components comprises polycarbonate having an average molecular weight from about 40,000 to about 60,000.

16. The flat panel display device of claim 15, wherein the peripheral components comprise:
a lamp holder provided on a lateral side of the light source and fixing and supporting the light source;
a frame mold side covering and supporting the lamp holder; and
a bottom chassis receiving the lamp holder and the frame mold side.

17. The flat panel display device of claim 15, wherein the panel assembly comprises a liquid crystal display panel.
